(19) United States
(12) Patent Application Publication
(10) Pub. No.: US 2018/0137440 A1
(43) Pub. Date: May 17, 2018

(54) Transport Charter System and a Method Thereof

(71) Applicants: Dev Kumar Vaidya, Mumbai Maharashtra (IN); Rajeev Wadhwa, Versova, Mumbai Maharashtra (IN)

(72) Inventor: Sachit Wadhwat, Versova, Mumbai Maharashtra (IN)

(21) Appl. No.: 15/574,640

(22) PCT Filed: May 14, 2016
(86) PCT No.: PCT/IN2016/050140

§ 371 Date: Nov. 16, 2017

(30) Foreign Application Priority Data
May 16, 2015 (IN) 1578/MUM/2015

(51) Int. Cl. G06Q 10/02; G06Q 30/02; G06Q 50/30; G06Q 50/14

(52) U.S. Cl. CPC G06Q 10/02; G06Q 50/14; G06Q 50/30; G06Q 30/0206

(57) ABSTRACT

A system for pricing and reserving charter vehicle services includes a central database, first and second real-time databases, and a controller. The central database receives and stores itinerary data. The controller searches the first real-time database to identify at least one route between the departure and destination locations and the second real-time database to determine whether a charter vehicle is capable of being operated on the routes. The controller further determines availability of the charter vehicle and the routes and determines feasibility of operating the charter vehicle on the routes, generates travel schedules, provides prices for travel schedules, receives payment for one of the travel schedules, and reserves the travel schedule.

### FIELD OF INVENTION

This invention relates to charter transport services and more particularly to a system and method for pricing and reserving charter vehicles.

### BACKGROUND OF THE INVENTION

Charter is the business of renting an entire transport vehicle like an aircraft, yacht, vanity van etc as opposed to booking individual seats on the transport vehicle, i.e., purchasing ticket through traditional transport services.

In case of aviation, a charter flight is a trip in an airplane or helicopter that is booked for a specific destination by one person or a group of people. It is often more expensive than a standard pre-scheduled flight, but exact pricing depends upon the type of aircraft, destination, fuel and crew charges.

Charter companies focus on individual private aircraft and itineraries, urgent or time-sensitive cargo, air ambulance and any other form of ad hoc air transportation. These air charter companies offer a large variety of aircrafts, such as helicopters and business jets. Charter jet categories include turbo props, light jets, mid-size jets, super mid-size jets, heavy jets, and airliners.

Currently, there aren't many service provider platforms available that can cater to the specific needs of an individual willing to book a chartered transport. Further, only very basic information is made available to the individual regarding the transport being booked, the travel time, the costs involved etc. Generally, when an individual wishes to book a charter service, the individual will call, for instance, the general aviation terminal at the particular airport that he is closest to or perhaps a travel agent. The customer then calls someone at the general aviation terminal to enquire about a chartered flight, where he/she would usually receive suggestion regarding a given charter operator and the individual is then given the telephone number of the charter operator. The charter operator may indicate to the individual that the requested itinerary cannot be met. The individual may then be directed to another operator and the entire process is extremely time consuming and cumbersome. Further, the individual may not be provided with any information relating to the transport vehicle like the aircraft, which may be of interest to him.

Further, the booking of a charter service through a travel agent involves delay in turn-around-time, lack of transparency, hidden charges, limited choice of aircrafts, and inflated prices.

Therefore, the existing solutions for charters have lack of transparency in charter pricing, lack of accessibility to source the right transport due to the scattered nature of the market, scope for human bias in pricing, and delays in booking (blocking the transport) due to the time lags involved in offline payment processes.

In view of the above problems, it is required to provide a convenient chartering system and method to make chartering as easy and convenient for an individual with accurate information.

Moreover, it is required to provide a system to avoid the pitfalls of prior chartering systems such as, insufficient, out-of-date or erroneous information.

### SUMMARY OF THE INVENTION

The objective of the present invention is to provide a system and method for pricing and reserving charter vehicle services.

In an embodiment of the present invention, a system for pricing and reserving charter vehicle services includes a central database, first and second real-time databases, and a controller. The central database receives and stores itinerary data. The itinerary data includes information of one or more departure and destination locations and information of date and time of travel. The first real-time database stores first real-time data corresponding to multiple routes between multiple locations. The first real-time data is indicative of availability of the routes. The second real-time database stores second real-time data corresponding to multiple charter vehicles. The second real-time data is indicative of availability of the charter vehicles. The controller retrieves the itinerary data from the central database and searches the first real-time database to identify at least one route between the departure and destination locations. The controller further searches the second real-time database to determine whether a charter vehicle is capable of being driven, flown, or sailed on the routes. The controller determines availability of the charter vehicle and the routes and feasibility of operating the charter vehicle on the routes. Thereby, the controller generates one or more travel schedules and determines a final price for the same. Further, the controller provides the final prices for the travel schedules and receives payment for one of the travel schedules, thereby reserving the charter vehicle.

Therefore, the system provides accurate pricing of the charter services and provides for online booking of charter vehicles, thereby overcoming the limitations of the prior-art systems.

### BRIEF DESCRIPTION OF DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a schematic block diagram of a system for pricing and reserving charter vehicles in accordance with an embodiment of the present invention;

FIG. 2 shows a schematic block diagram of the system of FIG. 1 in accordance with another embodiment of the present invention;

FIG. 3 shows a schematic block diagram of a system for pricing and reserving charter aircraft services in accordance with an embodiment of the present invention;

FIG. 4 shows a schematic block diagram of the system of FIG. 3 in accordance with another embodiment of the present invention; and

FIG. 5 shows a flow chart illustrating a method for pricing and reserving charter aircrafts in accordance with an embodiment of the present invention.

### DETAILED DESCRIPTION OF THE INVENTION

The embodiments herein and the various features and advantageous details thereof are explained further with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein.

Various embodiments of the present invention provide a system and method for pricing and reserving charter vehicle services.

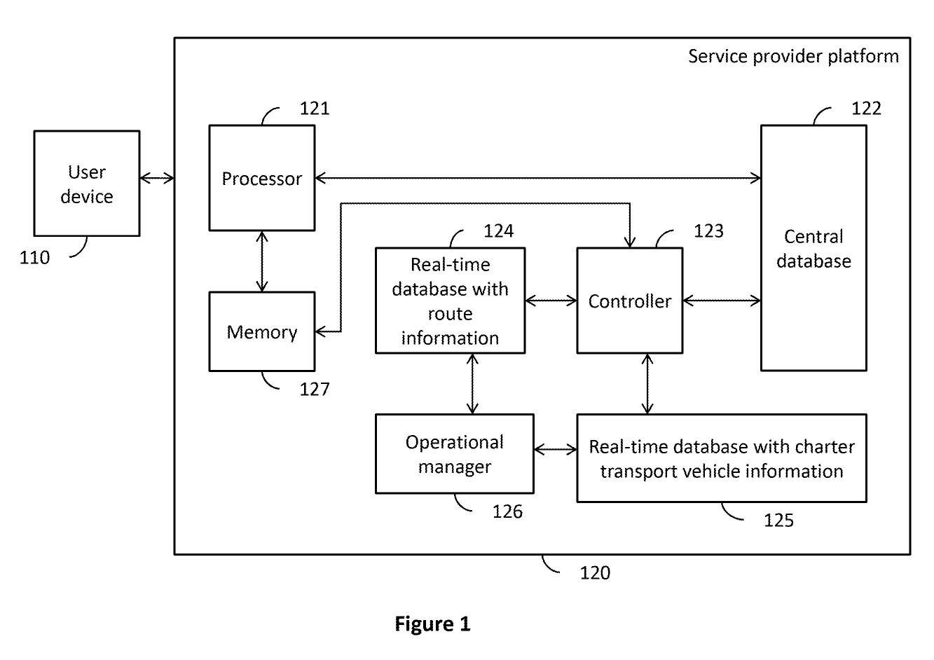

Referring now to FIG. 1, a schematic block diagram of a system for pricing and reserving charter vehicles is shown in accordance with an embodiment of the present invention. The system includes a user device (110) and a service provider platform (120). The service provider platform (120) includes a processor (121), a central database (122), a controller (123), a real-time database with route information (hereinafter referred to as ‘the first real-time database’) (124), a real-time database with charter transport vehicle information (hereinafter referred to as ‘the second real-time database’) (125), an operational manager (126), and a memory (127).

The charter vehicles may include various types of vehicles, such as, but not limited to, charter aircrafts, helicopters, and yachts. It will be understood by a person of ordinary skill in the art that the system will be applicable for any transport vehicles that are capable of travelling in air, on water, and on road without departing from the scope of the present invention.

The user device (110) is in communication with the service provider platform (120). The communication between the user device (110) and the service provider platform (120) may be wired or wireless in nature. Examples of the wired or wireless networks include Wi-Fi, cellular data (GPRS/EDGE/HSPA/LTE/LTE-A), WiMax, and Ethernet connections. Examples of the user device (110) include smart phones, personal computers, laptops, and tablets. The service provider platform (120) may be a server running on a server operating system.

The user device (110) sends itinerary data to the service provider platform (120). The itinerary data is stored in the central database (122). The itinerary data includes information of at least one departure location and at least one destination location. For instance, for a one way travel (for e.g. Mumbai to Delhi); the itinerary data includes one departure location and one destination location. However, for a multi-city travel (for e.g. Mumbai to Rajkot to Kolkata to Delhi), the itinerary data includes more than one destination locations and more than one departure locations. Further, the itinerary data also includes information related to the travel such as number of passengers, details of the services requested (for e.g. snacks, cabin crew, and multi-course meals), and details of the facilities within the charter vehicles (for e.g. baggage capacity, air show, lavatory, communication, and in-flight audio-video players). The itinerary data further includes information of date and time of travel. The central database (122) generates an enquiry identifier (ID) for the received itinerary data. The central database (122) sends the enquiry ID to the controller (123).

The first real-time database (124) is in communication with the controller (123). The first real-time database (124) stores first real-time data that includes information about multiple routes between the multiple destination and departure locations (for e.g. two routes connecting Mumbai to Delhi, one route connecting Mumbai to Pune). The first real-time data includes information of environmental factors affecting the route (for e.g. weather conditions such as fog or thunderstorms), administrative time restrictions of the departure and destination airports (for e.g. operational timings of the airports), and physical parameters of the departure and destination locations (for e.g. runway length of the airports). Further, the first real-time data includes information of optimum routes between multiple locations, and the distance between multiple locations. The first real-time data also includes availability of the routes or airports.

The second real-time database (125) is in control with the controller (123). The second real-time database (125) stores second real-time data that includes information about multiple charter vehicles. The second real-time data includes information of physical parameters of charter vehicles (for e.g. seating capacity of the charter vehicle), endurance of each charter vehicle, Flight and Duty Time Limitations (FDTL) of crew corresponding to each charter vehicle, and travel time of each charter vehicle on each route. The travel time of each charter vehicle is calculated based on performance, efficiency, and speed of the charter vehicle. In an example, the second real-time data includes information of fuel efficiency of the charter vehicle. The second real-time data also includes availability of the charter vehicles.

The processor (121) and the controller (123) are connected to the memory (127). The memory (127) is a non-transitory and tangible computer readable storage media. Examples of the memory (127) include, but are not limited to, non-volatile and hard-coded type media (for e.g. read only memories (ROMs), compact disks (CD-ROMs), and digital versatile disks (DVD-ROMs)), erasable and electrically programmable read only memories (EEPROMs), and recordable type media such as floppy disks, hard disk drives, flash drives, memory sticks, memory cards and so on.

The memory (127) stores a set of computer-executable machine readable instructions that are executed by the processor (121), or the controller (123) or both.

The controller (123) searches the first real-time database (124) to identify the routes between the departure and destination locations corresponding to the enquiry ID. The controller (123) then searches the second real-time database (125) to identify charter vehicles capable of travelling on the identified routes that satisfy the conditions in the received itinerary data. When the controller (123) determines that there are charter vehicles capable of travelling on the routes, the controller (123) determines availability of the charter vehicles. Thereafter, the controller (123) determines feasibility of operating the available charter vehicles on the routes. The controller (123) then generates a travel schedule for each feasible route and available charter vehicles for corresponding route. The travel schedule includes information such as type of charter vehicle, date and time of travel, and the services included in the charter vehicle. The controller (123) determines a final price for each travel schedule and sends the travel schedules and the corresponding final prices to the user device (110). The user device (110) displays the travel schedule and the corresponding final prices and receives a booking request from a user.

The user device (110) sends the booking request to the service provider platform (120). Thereafter, the user completes payment and reserves a desired travel schedule.

When the controller (123) determines that there are no charter vehicles that are capable of flying, sailing, or driving on the routes between the departure and destination locations indicated by the enquiry ID, the controller (123) generates an alternate travel schedule including at least one of an alternate charter vehicle, an alternate route, and an alternate time of travel based on the itinerary data.

The operational manager (126) updates the first and second real-time data stored in the first and second real-time databases (124 and 125). In an example, the operational manager (126) is in communication with external databases for updating the first and real-time data. Examples of the external databases include charter aircraft operator database. The first and second real-time data are updated on real-time basis and are synchronized with the external databases.

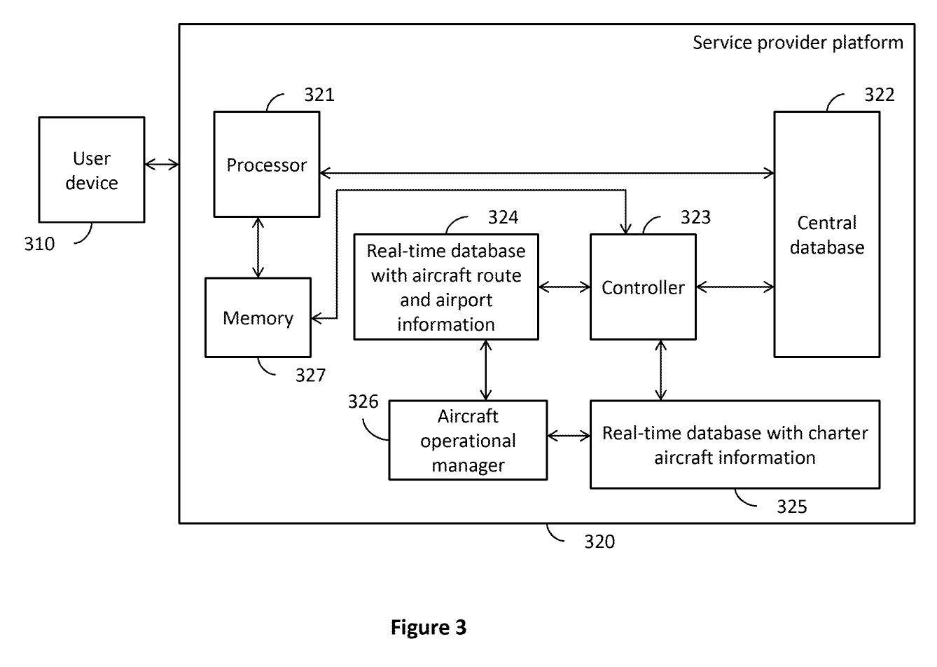

Referring now to FIG. 2, a schematic block diagram of a system for pricing and reserving charter vehicles is shown in accordance with another embodiment of the present invention. The system includes a server (220).

The server (220) includes a database (230). The server (220) is in communication with a user (240), an admin (241), and a machine owner (242). The server (220) further includes multiple modules (251-261), namely, an input module (251), an enquiry process module (252), a machine selection module (253), a machine usage time module (254), a seat check module (255), an endurance check module (256), a check availability module (257), a cost calculation module (258), an operational time module (259), a machine sorting module (260), and an optimization module (261).

In an embodiment, the modules (251-261) are software modules and are executed by at least one of the controller (223) and the processor (221).

The user (240) sends the itinerary data to the server (220). The itinerary data is received by the input module (251) and is stored in the database (230). The enquiry process module (252) identifies the routes between the departure and destination locations. The machine selection module (253) checks whether there exist any charter vehicles capable of being driven, flown, or sailed on the routes. The machine time usage module (254) calculates total usage time of the charter vehicles. The seat check module (255) determines whether the charter vehicle can accommodate required number of passengers. The endurance check module (256) checks for the endurance restrictions of the charter vehicle. The check availability module (257) checks the availability of the charter vehicles and generates travel schedules. The cost calculation module (258) calculates costs of the travel schedules. The operational time module (259) checks whether the time of travel falls within non-operational time of the destination and departure locations. The machine sorting module (260) presents a sorted list of available charter vehicles and corresponding travel schedules. The optimization module (261) determines optimum travel schedules based on the first real-time data and presents the optimum travel schedules to the user (240). The database (230) is accessible to the admin (241) and the machine owner (242). The admin (241) and the machine owner (242) update the database (230).

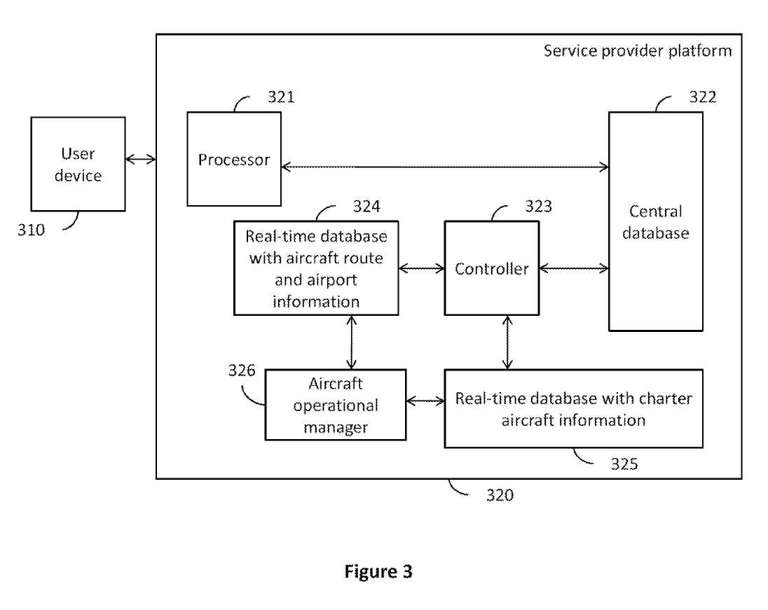

Referring now to FIG. 3, a schematic block diagram of a system for pricing and reserving charter aircraft services is shown in accordance with another embodiment of the present invention.

The system includes a user device (310) and a service provider platform (320). The service provider platform (320) includes a processor (321), a central database (322), a controller (323), a real-time database with aircraft route and airport information (hereinafter referred to as ‘the third real-time real-time database’) (324), a real-time database with charter aircraft information (hereinafter referred to as ‘the fourth real-time database’) (325), an aircraft operational manager (326), and a memory (327).

In an embodiment, the user device (310) is structurally and functionally similar to the user device (110) and the service provider platform (320) is structurally and functionally similar to the service provider platform (120). Further, the processor (321) is structurally and functionally similar to the processor (121), the third and fourth real-time databases (324 and 325) are structurally and functionally similar to the first and second real-time databases (124 and 125), and the controller (323) is structurally and functionally similar to the controller (123). The third real-time database (324) further includes regulatory information corresponding to the aircraft routes and the airports. The fourth real-time database (325) further includes regulatory information corresponding to the charter aircrafts.

The memory (327) is a non-transitory and tangible computer readable storage media. Examples of the memory (327) include, but are not limited to, non-volatile and hard-coded type media (for e.g. read only memories (ROMs), compact disks (CD-ROMs), and digital versatile disks (DVD-ROMs)), erasable and electrically programmable read only memories (EEPROMs), and recordable type media such as floppy disks, hard disk drives, flash drives, memory sticks, memory cards and so on. The memory (327) is connected to the processor (321) and the controller (323).

The memory (327) stores a set of computer-executable machine readable instructions that are executed by the processor (321), or the controller (323) or both.

The user device (310) is in communication with the service provider platform (320). The user device (310) sends itinerary data to the service provider platform (320). The itinerary data is stored in the central database (322). The central database (322) generates an enquiry identifier (ID) for the received itinerary data. The central database (322) sends the enquiry ID to the controller (323). The controller (323) receives the enquiry ID from the central database (322). The controller (323) searches the third real-time database (324) to identify aircraft routes between the departure and destination airports corresponding to the enquiry ID. The controller (323) then searches the fourth real-time database (325) to identify charter aircrafts that are capable of travelling on the identified aircraft routes based on the itinerary data. When the controller (323) determines that there are charter aircrafts capable of travelling on the routes, the controller (323) determines availability of the charter aircrafts. Thereafter, the controller (323) determines feasibility of operating the available charter aircrafts on the routes. The controller (323) then generates a travel schedule for each feasible route and available charter aircrafts for corresponding route. The controller (323) determines a final price for each travel schedule and sends the travel schedules and the corresponding final prices to the user device (310). The user device (310) displays the travel schedule and the corresponding final prices and receives a booking request from a user. The user device (310) sends the booking request to the service provider platform (320). Thereafter, the user completes payment and reserves a desired travel schedule. The aircraft operational manager (326) updates the third and fourth real-time data stored in the third and fourth real-time databases (324 and 325).

When the controller (323) determines that there are no charter aircrafts that are capable of flying on the routes between the departure and destination locations indicated by the enquiry ID, the controller (323) generates an alternate travel schedule including at least one of an alternate charter aircraft, an alternate route, and an alternate time of travel based on the itinerary data.

In an embodiment of the present invention, the service provider platform (320) calculates precise flying time of an aircraft, thereby providing accurate results to the user. In an advantageous aspect, the service provider platform (320) of the present invention evades human intervention in calculating the flying time. Generally, though the aircraft has a good cruising speed, the cruising speed is applicable only after attaining a certain altitude. Merely dividing the cruising speed with the route distance does not determine accurate results because the aircraft is maintain to attain the cruising speed when it starts descending for landing. Therefore, there is a need to add a bias for most routes as per historic data or human judgement. The present system is advantageous as the service provider platform (320) estimating a required bias for each route and adds the required for every unique route. In an example, the service provider platform (320) divides the aircraft cruising speed into two—one which is the average speed of the aircraft till it ascends to and descends from the cruising altitude and the other being the average speed attained at the cruising altitude.

In an embodiment the present invention provides accurate endurance amongst other operative checks of the aircraft at pre-booking stage. The service provider platform (320) factors pre-operative checks which are otherwise handled by specific departments in the organization. As a result of these pre-operative checks, the change in itinerary or even cost of current practice is avoided as the aircraft quote is generated after the pre operative checks unlike in the past. For example, the aircraft endurance varies with the passenger count as the ability to carry fuel load is directly proportional to the passenger count. The aircraft endurance is a pilots' domain as of today, and we have witnessed that even one passenger being added to the trip may end up making the entire trip on that aircraft not feasible. The service provider platform (320) does all the relevant checks related to aircraft endurance, such as, fuel reserve to hover or to fly to an alternate city, thereby resolving the operational issues faced by the prior-art systems.

In an advantageous aspect the service provider platform (320) provides optimum solutions to FDTL issues that prevail as the regulatory authorities imposes a few restrictions to the crew members on their duty hours, flying hours, number of landings, etc in a defined time which may hamper the itinerary. The service provider platform (320) determines optimum solutions for a case in which an FDTL issue arises, thereby eliminating uncertainty faced by prior-art systems.

The present invention is advantageous in providing optimum solutions to NOTAM and watch hours. Typically, airports are shut for various intervals on a given day. Therefore, if preferred itinerary of the user is such that an aircraft booked through the system of the present invention is attempting to land or take off at the time the airport is non-operational, the service provider platform (320) prompts a message to the user and the optimum solution is determined by the service provider platform (320) to assist the user.

In an illustrative embodiment of the present invention, it is noteworthy that according to regulatory authority in India, the crew needs to be provided with accommodation of a certain standard if the halt at any destination other than the aircraft base is for more than 4 hours. The charge for crew accommodation is charged to the user. In most one way journeys, the element of crew accommodation are not present and hence is ignored. For example, if a Heavy Jet is scheduled for departure from Mumbai at 6.45 AM on Monday and the Heavy Jet reaches Goa at 7.55 AM as per historic data, and if the airport at Goa is non-operational on Monday from 8 am to 1 pm, the Heavy Jet cannot return back to the base immediately after the drop and thus crew accommodation would be needed. The present invention is advantageous in providing the aforementioned information to the user with real-time updates.

In yet another illustrative embodiment of the present invention, the service provider platform (320) provides positioning and re-positioning of the aircraft. For example, if the itinerary data includes a request for a specific aircraft, such as, a Heavy Jet from Mumbai to Delhi, and if the Heavy Jet is positioned at Goa during time of travel indicated by the itinerary data, the service provider platform (320) generates a travel schedule that includes positioning and re-positioning of the Heavy Jet, i.e., the service provider platform (320) generates a travel schedule for Goa to Mumbai (positioning), Mumbai to Delhi, and Delhi to Goa (re-positioning).

In an embodiment of the present invention, the service provider platform (320) generates final pricing quotes for the user which is otherwise susceptible to errors owing to the varied nature of airstrips across the world, thereby avoiding the errors in the prior-art systems. The final price is calculated based on specific charter aircraft rates, airport charges, crew accommodation and transportation charges, and calculation of the flying time of the charter aircraft. The specific charter aircraft rates include, but are not limited to, crew charges and fuel charges. The airport charges include, but are not limited to, ground handling charges, charges for transfers within the airport, charges for landing and parking the charter aircraft, and charges for extension of regular operational timings of the airports. The flying time of the charter aircraft includes air time and taxiing time. Therefore, the final price is a substantially accurate price.

In an additional embodiment of the present invention, the system of the present invention is advantageous in providing unique transfer logic for promotional flights that return empty to the desired location for the purpose of positioning or repositioning when final price for these flights has already been paid for by the user. The system provides a method for the user who has already paid for the flight, to transfer the promotional flights. The system also provides for drop of final prices every hour till the flight takes off.

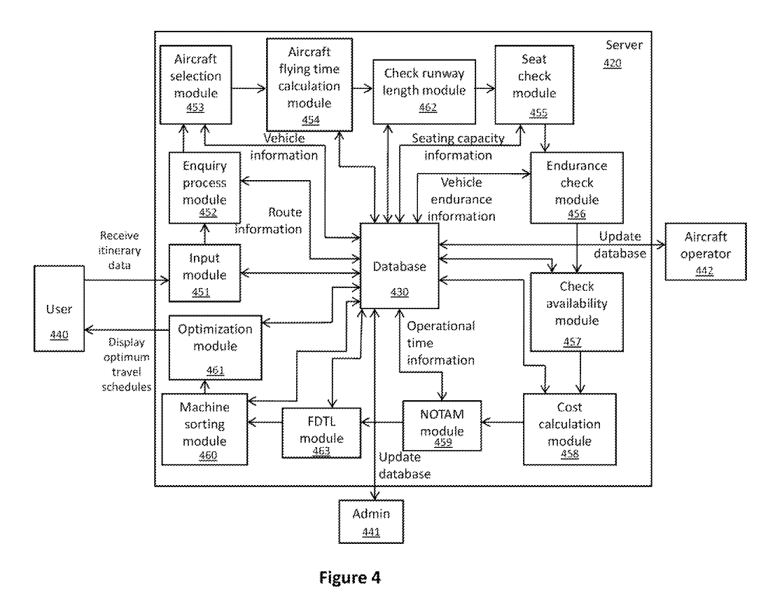

Referring now to FIG. 4, a system for pricing and reserving charter aircraft services is shown in accordance with another embodiment of the present invention. The system includes a server (420). The server (420) is in communication with a user (440). The server (420) includes a database (430), an input module (451), an enquiry process module (452), an aircraft selection module (453), an aircraft flying time calculation module (454), a check runway length module (462), a seat check module (455), an endurance check module (456), a check availability module (457), a cost calculation module (458), a Notice to Airmen (NOTAM) module (459), a Flight and Duty Time Limitations (FDTL) module (463), a machine sorting module (460), and an optimization module (461).

The user (440) sends the itinerary data to the server (420). The itinerary data is received by the input module (451) and is stored in the database (430). The enquiry process module (452) identifies the routes between the departure and destination airports. The aircraft selection module (453) checks whether there exist any charter aircrafts capable of being driven on the routes. The aircraft flying time calculation module (454) calculates the flying time of the charter aircrafts. The check runway length module (462) reads runway information of the departure and destination airports from the second real-time database (424). The check runway length module (462) further determines whether the charter aircrafts are capable o landing or taking off from the departure airports. The seat check module (455) determines whether the charter aircraft can accommodate required number of passengers. The endurance check module (456) checks for the endurance restrictions of the charter aircraft. The check availability module (457) checks the availability of the charter aircrafts and generates the travel schedules. The cost calculation module (458) calculates costs for the travel schedules. The NOTAM module (459) checks whether the time of travel falls within non-operational time of the destination and departure aircrafts. The FDTL module (463) checks whether the flying time restrictions and rest requirements are satisfied for the travel schedule. The machine sorting module (460) presents a sorted list of available charter vehicles and corresponding travel schedules. The optimization module (461) determines optimum travel schedules and presents the optimum travel schedules to the user (440).

The database (430) is accessible to the admin (441) and the aircraft operator (442). The admin (441) and the aircraft operator (442) update the database (430).

In an advantageous embodiment of the present invention, the system acts as a global distribution system (GDS). In commercial aviation, the GDS is a network that enables automated transactions between travel service providers (for e.g. airlines) and travel agencies. The system performs functions of a GDS, such as, maintaining a global database of availability of the charter aircrafts, determining pricing of the travel schedules, and providing to multiple travel agencies an access (for e.g. a subscription-based paid access) to the global database.

The system, as a GDS, facilitates the travel agencies to choose and book charter aircrafts and corresponding services. For example, when a travel agency requests a reservation on a service of a particular charter aircraft, the GDS routes the request to corresponding charter aircraft operator's computer reservation system.

In another advantageous embodiment of the present invention, the system maintains a calendar based management system wherein the system maintains a record of positioning and availability of the charter aircrafts for each day and time of the day.

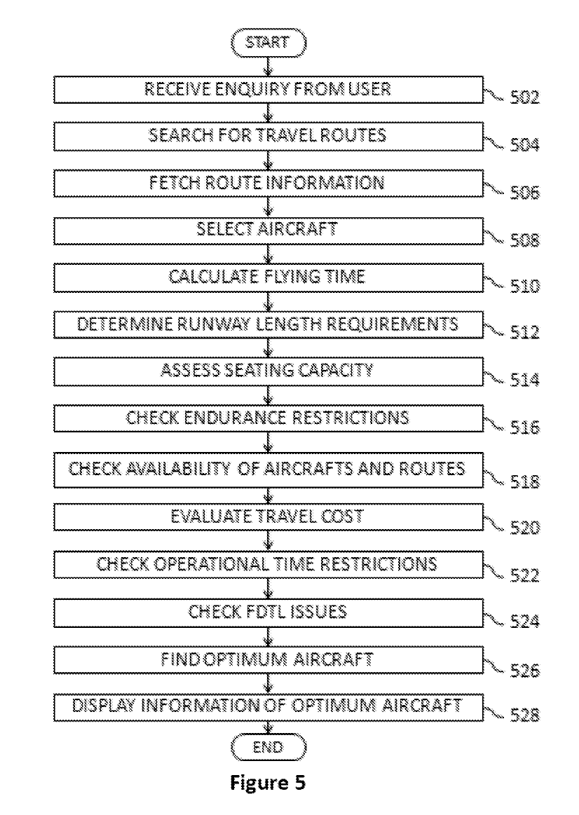

Referring now to FIG. 5, a flow chart illustrating a method for pricing and reserving charter aircrafts is shown in accordance with an embodiment of the present invention. The flowchart is explained below with respect to the server (420) of FIG. 4.

In operation, at step 502, the input module (451) receives an enquiry from the user (440). The enquiry includes the itinerary data. At step 504, the enquiry process module (452) queries the database (430). At step 506, the enquiry process module (452) fetches information about the travel routes from the database (430). At step 508, the aircraft selection module (453) identifies charter aircrafts for the travel routes. At step 510, the aircraft flying time calculation module (454) calculates the flying time for the charter aircrafts. At step 512, the check runway length module (462) determines runway lengths at the departure and destination airports and checks whether the charter aircrafts are capable of landing or taking off from the departure and destination airports based on the runway lengths. At step 514, the seat check module (455) assesses seating capacity of the charter aircrafts. At step 516, endurance check module (456) checks for the endurance restrictions of the charter aircrafts. At step 518, the check availability module (457) checks for the availability of the charter aircrafts. At step 520, the cost calculation module (458) determines travel schedules and calculates costs for the travel schedules. At step 522, the NOTAM module (459) checks for operational time restrictions of the departure and destination airports. At step 524, the FDTL module (463) checks for the FDTL restrictions for the travel schedules. At step 526, the optimization module (461) determines the optimum travel schedule. At step 528, the optimization module (461) displays the optimum travel schedule to the user (440).

Therefore, the system provides accurate pricing of the charter services and provides for online booking of charter vehicles, thereby overcoming the limitations of the prior-art systems.

The foregoing description of the specific embodiments will reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification(s) within the scope of the embodiments as described herein.

1.-10. (canceled)

11. An online reservation system comprising:
an input/output module configured to communicate with a network-enabled user device via a network connection;
a memory configured to store a set of computer-executable machine readable instructions;
a processor coupled with the memory, the processor configured to execute the set of computer-executable machine readable instructions;
a central database;
a first real-time database;
a second real-time database, and
a controller in communication with the first and second real-time databases, the central database, and the processor, the controller configured to:
receive from the network-enabled user device, the itinerary data pertaining to one or more travel itinerary;
store the itinerary data in the central database;
provide real-time information relating to at least one departure location, at least one destination location, and a time-stamp information from the itinerary data;
provide real-time information relating to a plurality of charter vehicles;
determine availability and operating condition of a charter vehicle on at least one travel route based on the itinerary data and on a first real-time data and a second real-time data;
determine feasibility of operating the charter vehicle on the at least one travel route;
generate at least one travel schedule for the at least one feasible travel route based on the itinerary data and on the first and second real-time data, and
render the at least one travel schedule on the user device,
wherein the first real-time database is configured to store first real-time data corresponding to a plurality of routes between a plurality of locations, said first real-time data indicating availability of the plurality of routes, and the second real-time database is configured to store second real-time data corresponding to a plurality of charter vehicles, said second real-time data indicating availability of the plurality of charter vehicles, and wherein the first and second real-time data stored in the first and second real-time databases are updated in real-time.

12. The system of claim 11, wherein the controller is further configured to determine and provide a final price for each travel schedule based on the itinerary data and the first and second real-time data, and receive payment for at least one travel schedule.

13. The system of claim 11, wherein the plurality of charter vehicles includes charter aircrafts, helicopters, and yachts.

14. The system of claim 11, wherein the first real-time data includes information of environmental factors affecting the route, administrative time restrictions of the departure and destination locations, and physical parameters of the departure and destination locations.

15. The system of claim 12, wherein the first real-time data includes operational timings of airports at the departure and destination locations and dimensions of runways of the airports.

16. The system of claim 15, wherein the final price is a real-time price calculated based on plurality of real-time charges including charter vehicle rates, airport charges, crew accommodation and transportation charges, and calculation of the flying time of the charter vehicle.

17. The system of claim 11, wherein the second real-time data includes information of physical parameters of each of the plurality of charter vehicles, endurance restrictions of each of the plurality of charter vehicles, and time restrictions of a crew corresponding to each of the plurality of charter vehicles.

18. The system of claim 11, wherein the second real-time data includes seating capacity of the charter vehicle, fuel efficiency of the charter vehicle, and flying time restrictions of pilots.

19. The system of claim 11, wherein the controller is further configured to provide an alternate travel schedule including at least one of an alternate travel route, an alternate charter vehicle, and an alternate time of travel when the controller determines that no charter vehicle is operable on the at least one travel route based on the itinerary data.

20. A computer implemented method, for reserving a charter vehicle, the method comprising:
receiving, from a network-enabled user device, itinerary data pertaining to one or more travel itinerary;
storing the itinerary data in a central database;
providing real-time information relating to at least one departure location, at least one destination location and a time-stamp information from the itinerary data;
providing real-time information relating to a plurality of charter vehicles;
determining availability and operating condition of a charter vehicle on at least one travel route based on the itinerary data and on a first real-time data and a second real-time data;
determining feasibility of operating the charter vehicle on the at least one travel route based on the itinerary data;
generating at least one travel schedule for the at least one feasible travel route based on the itinerary data and the first and second real-time data; and
rendering the at least one travel schedule on the user device, and
wherein the first real-time database is configured to store first real-time data corresponding to a plurality of routes between a plurality of locations, said first real-time data indicating availability of the plurality of routes, and the second real-time database is configured to store second real-time data corresponding to a plurality of charter vehicles, said second real-time data indicating availability of the plurality of charter vehicles, and wherein the first and second real-time data stored in the first and second real-time databases are updated in real-time.

21. The method of claim 11, further comprising determining and providing the final price for each travel schedule based on the itinerary data and the first and second real-time data; and receiving payment for at least one travel schedule.

22. The method of claim 10, wherein the plurality of charter vehicles includes charter aircrafts, helicopters, and yachts.

23. The method of claim 10, wherein the first real-time data includes information of environmental factors affecting the route, administrative time restrictions of the departure and destination locations, and physical parameters of the departure and destination locations.

24. The method of claim 11, wherein the first real-time data includes operational timings of airports at the departure and destination locations and dimensions of runways of the airports.

25. The system of claim 24, wherein the final price is a real-time price calculated based on a plurality of real-time charges including vehicle rates, airport charges, crew accommodation and transportation charges, and calculation of the flying time of the charter vehicle.

26. The method of claim 11, wherein the second real-time data includes information of physical parameters of each of the plurality of charter vehicles, endurance restrictions of each of the plurality of charter vehicles, and time restrictions of a crew corresponding to each of the plurality of charter vehicles.

27. The method of claim 10, wherein the second real-time data includes seating capacity of the charter vehicle, fuel efficiency of the charter vehicle, and flying time restrictions of pilots.

28. The method of claim 10, further comprising providing an alternate travel schedule including at least one of an alternate travel route, an alternate charter vehicle, and an alternate time of travel after determining that no charter vehicle is operable on the at least one travel route based on the itinerary data.
